(19) United States
(12) Patent Application Publication
(10) Pub. No.: US 2024/0308033 A1
(43) Pub. Date: Sep. 19, 2024

(54) MULTIFUNCTIONAL ELECTRIC WRENCH

(71) Applicant: Leib Breuer, Chester, NY (US)

(72) Inventor: Leib Breuer, Chester, NY (US)

(21) Appl. No.: 18/442,147

(22) Filed: Feb. 15, 2024

Related U.S. Application Data
(60) Provisional application No. 63/490,348, filed on Mar. 15, 2023.

(51) Int. Cl. B25B 21/00

(52) U.S. Cl. CPC B25B 21/002

(57) ABSTRACT

An electric wrench for tightening and loosening nuts and bolts easily. The wrench includes an upper power wrench encased within a circumferential ring, equipped with adjustable interior wrench gears controlled by internal motors and a locking spring mechanism to accommodate various nut and bolt sizes. A pair of quarter ring guide bars, linked to corresponding user-operated arms, provides gear engagement through a chain mechanism thereby facilitating efficient rotational motion of the upper wrench. A second integrated wrench connected to corresponding gear mechanism obviates the need for a secondary tool and enhances user convenience.

### CROSS-REFERENCE TO RELATED APPLICATION

The present application claims priority to, and the benefit of, U.S. Provisional Application No. 63/490,348, which was filed on Mar. 15, 2023 and is incorporated herein by reference in its entirety.

### FIELD OF THE INVENTION

The present invention relates generally to the field of electric wrenches. More specifically, the present invention relates to a novel wrench that includes an upper wrench with an adjustable head to accommodate different nuts and bolts and a second wrench to secure threaded portion of the nut or bolt. The wrench includes a ¾ ring, equipped with adjustable interior wrench gears controlled by internal motors and a locking spring mechanism to accommodate various nut and bolt sizes. Separate gears are attached to the upper wrench and the second wrench. Accordingly, the present disclosure makes specific reference thereto. Nonetheless, it is to be appreciated that aspects of the present invention are also equally applicable to other like applications, devices, and methods of manufacture.

### BACKGROUND

By way of background, a wrench or spanner is a mechanical tool designed for the primary purpose of turning or tightening nuts, bolts, pipes, and various fasteners. A wrench is an essential tool in mechanics, plumbing, construction, and more where fastening and unfastening components are routine tasks. The primary function of a wrench is to turn nuts and bolts. Wrenches are designed to grip onto these nuts and bolts and apply the necessary rotational force to tighten or loosen them. Further, wrenches are used for both tightening (clockwise) and loosening (counterclockwise) nuts and bolts. Traditional wrenches include open-end wrench, combination wrench, socket wrench, pipe wrench, torque wrench, and more.

Using traditional wrenches manually can require a significant amount of physical energy, especially when dealing with large fasteners. It can lead to fatigue and potential injury. Further, using traditional wrenches can be time-consuming because they require continuous turning and pulling. Many routine tasks of wrenches require the use of both hands especially dealing with nuts with long threads, which can be challenging when a worker needs one hand free for another task or for stability. Operators, both professionals and DIY operators desire an improved wrench that can be used to connect and adjust pipes and nuts that have long threads.

Many traditional wrench ratchets are not compatible with power tools and are not ideal for connecting and adjusting nuts in confined spaces. Also, operators are required to carry wrenches of different sizes which are both expensive and difficult to store. People desire an improved wrench to overcome problems of the prior art.

Therefore, there exists a long felt need in the art for an improved wrench device that integrates the functionality of a traditional ratchet wrench with the power of an electric tool. There is also a long felt need in the art for a wrench device that is well-suited for plumbers, technicians, and professionals who frequently work with pipes or nuts in challenging conditions. Additionally, there is a long felt need in the art for an improved wrench that provides an additional wrench component to provide a tight grip to the threaded portion of a threaded nut. Moreover, there is a long felt need in the art for a wrench device that accommodates different sizes of nuts and bolts. Further, there is a long felt need in the art for a novel wrench device that is an innovative combination of a wrench ratchet and an electric power tool. Furthermore, there is a long felt need in the art for a wrench device that obviates the need to carry multiple wrenches of different sizes. Finally, there is a long felt need in the art for an improved wrench device that is a cost-effective and space-saving solution for professionals who work with a variety of fasteners.

The subject matter disclosed and claimed herein, in one embodiment thereof, comprises an electric wrench device. The wrench device is adapted to accommodate different sizes of nuts and bolts using an adjustable head. The wrench device further comprising a ring component designed for adjustable opening and closing, configured to securely engage nuts or bolts for the purpose of tightening or loosening, a top-mounted gear mechanism for an upper wrench, suitable for attachment to a drill, facilitating powered operation of a first wrench, a secondary wrench for enhanced torque and control and to secure threaded portion of a pipe, and interchangeable inner head component capable of accommodating various wrench sizes, further equipped with a locking spring mechanism to ensure secure fastening during operation.

In this manner, the electric wrench device of the present invention accomplishes all of the forgoing objectives and provides users with a hybrid device that integrates the functionality of a traditional ratchet wrench with the power of an electric tool. The device can be used in situations where the nuts or connections are surrounded or where long threads make it difficult to use traditional tools effectively. The device secures grip on bottom connections without requiring any other tool. The device can be used to accommodate different sizes of nuts and bolts for an easy operation.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an electric wrench device. The wrench device further comprising a ring component designed for adjustable opening and closing, configured to securely engage nuts or bolts for the purpose of tightening or loosening, a top-mounted gear mechanism, suitable for attachment to a drill, facilitating powered operation of a first wrench, a secondary wrench or tool for enhanced torque and control, and interchangeable inner head component capable of accommodating various wrench sizes, further equipped with a locking spring mechanism to ensure secure fastening during operation.

In yet another embodiment, an electric wrench apparatus, designed to streamline the process of tightening and loosening nuts and bolts for technicians and mechanics is disclosed. The wrench includes an upper wrench, serving as a power wrench, configured for coupling to a power tool, wherein the upper wrench is set within a ¾ ring (i.e., ¾ of a circumference) having an exterior surface with a gear-like structure, the upper wrench has an adjustable head to accommodate various sizes of nuts and bolts, a pair of quarter ring guide bars affixed to the upper wrench, each connected to a respective arm, and a chain adapted to traverse on the guide bars for adjusting the wrench, and a spring mechanism for facilitating the locking/unlocking of gears. A second wrench is integrated into the apparatus, obviating the need for a secondary tool during operation, wherein coupling the upper wrench with the power tool obviates the requirement for extensive physical effort and time, enhancing the efficiency of plumbers and technicians in connecting and disconnecting pipes and connections.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an electric wrench of the present invention in accordance with the disclosed architecture;

FIG. 2 illustrates an isolated view of inside of the inside-gear-wrench in accordance with the disclosed structure;

FIG. 3 illustrates the structure of the guide bars and associated arms for the inside-gear-wrench in accordance with the disclosed structure;

FIG. 4 illustrates a bottom perspective view of the multifunctional electric wrench of the present invention in accordance with the disclosed structure;

FIG. 5 illustrates a perspective view of the second wrench in accordance with the disclosed structure;

FIG. 6 illustrates the use of worm gears in the electric wrench device of the present invention in accordance with the disclosed structure;

FIG. 7 illustrates the two gears method of the electric wrench for placing a pipe for drilling in accordance with the disclosed structure;

FIG. 8 illustrates another perspective view of the electric wrench of the present invention in accordance with the disclosed structure;

FIG. 9 illustrates the isolated view of the chain used in the electric wrench of the present invention in accordance with the disclosed structure; and

FIG. 10 illustrates the use of the wrench to push around a pipe in accordance with the disclosed structure.

FIG. 11 illustrates a ring that is completely closed and two half rings driven by one gear

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved wrench device that integrates the functionality of a traditional ratchet wrench with the power of an electric tool. There is also a long felt need in the art for a wrench device that is well-suited for plumbers, technicians, and professionals who frequently work with pipes or nuts in challenging conditions. Additionally, there is a long felt need in the art for an improved wrench that provides an additional wrench component to provide a tight grip to the threaded portion of a threaded nut. Moreover, there is a long felt need in the art for a wrench device that accommodates different sizes of pipes nuts and bolts. Further, there is a long felt need in the art for a novel wrench device that is an innovative combination of a wrench ratchet and an electric power tool. Furthermore, there is a long felt need in the art for a wrench device that obviates the need to carry multiple wrenches of different sizes. Finally, there is a long felt need in the art for an improved wrench device that is a cost-effective and space-saving solution for professionals who work with a variety of fasteners.

The present invention, in one exemplary embodiment, is an electric wrench apparatus. The wrench includes an upper wrench, serving as a power wrench, configured for coupling to a power tool, wherein the upper wrench is set within a ¾ ring (i.e., ¾ circumference) having an exterior surface with a gear-like structure, the upper wrench has an adjustable head to accommodate various sizes of nuts and bolts, a pair of quarter ring guide bars affixed to the upper wrench, each connected to a respective arm, and a chain adapted to traverse on the guide bars, facilitating the unlocking and adjusting of gears. A second wrench is integrated into the apparatus, obviating the need for a secondary tool during operation and to secure the threaded portion of a bolt, pipe, and the like.

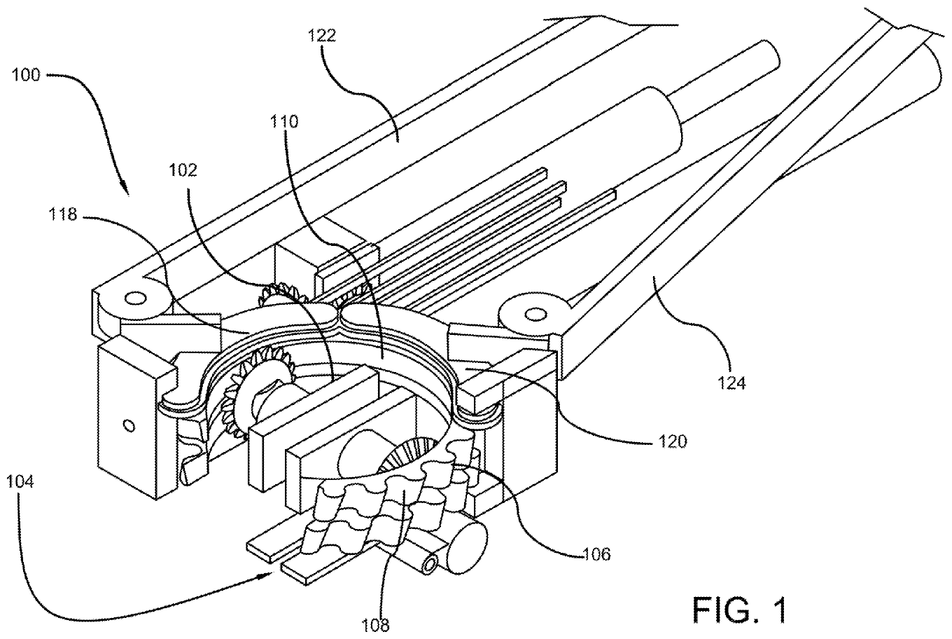

Referring initially to the drawings, FIG. 1 illustrates a perspective view of one potential embodiment of the electric wrench of the present invention in accordance with the disclosed architecture. The electric wrench 100 is designed to simplify the process of tightening and loosening pipes nuts and bolts for technicians and mechanics. The wrench 100 uses mechanical advantage of a traditional wrench with the power of an electric drill, making the task of working with fasteners more efficient and less physically demanding. More specifically, the improved wrench 100 of the present invention includes an upper or first wrench portion 102 which is the power wrench and a lower or second wrench portion 104. The first or power wrench portion 102 is used for coupling to a power plier which functions like a drill. The second wrench portion 104 obviates use of a second tool such as a tool used in the other hand by an operator. Coupling of the upper wrench portion 102 with the drill obviates the use of physical energy and the time needed for plumbers and technicians to connect and disconnect pipes and connections.

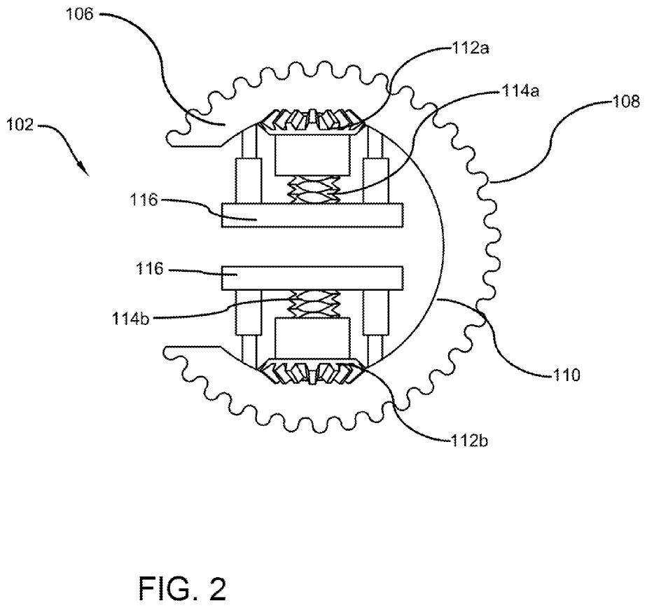

Referring to FIGS. 1 and 2, the upper wrench portion 102 is set in a ¾ ring or ¾ circular mount 106. The ring or circular mount 106 has an exterior surface 108 and an interior surface 110. The exterior surface 108 has a gear like structure. Further, the upper wrench portion 102 has inside wrench gears 112a, 112b which are pushed or biased into the inner surface 110 of the ring or circular mount 106 by corresponding internal springs 114a, 114b. An adjustable head 116 adjusts the wrench portion 102 and the adjustable head 116 is attached to the inside wrench gears 112a, 112b via the corresponding springs 114a, 114b. The internal springs 114a, 114b locks expansion and rotation of the upper wrench portion 102 by locking the adjustable head 116. The wrench portion 102 using the adjustable head 116 functions like an adjustable wrench and can be adjusted to accommodate different sizes of pipes nuts and bolts.

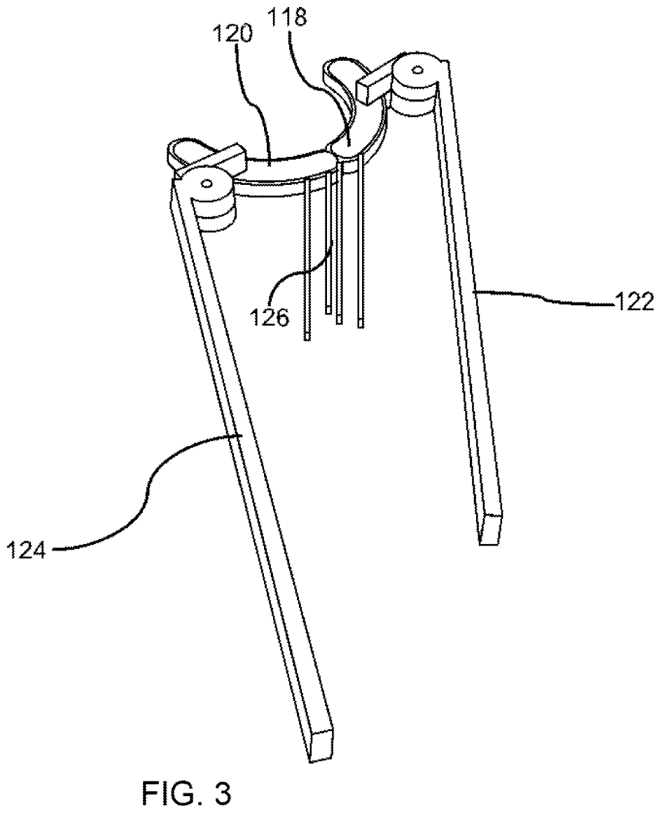

Referring now to FIGS. 1 and 3, a pair of quarter ring guide bars 118, 120 are positioned on the top of the upper wrench portion 102 and each quarter ring guide bar is attached to a corresponding arm. The first quarter ring guide bar 118 is attached to the first arm 122 and the second quarter ring guide bar 120 is attached to the second arm 124. A chain 126 adapted to run along the guide bars 118, 120 and is drive the inner gears to adjust the wrench. Springs 114a, 114b push the locked gears 112a, 112b, respectively, to unlock the gears 112a, 112b when the arms 122, 124 are pushed by a user. The wrench portion 102 is adjusted by rotating of the two gears 112a, 112b and one gear drives the wrench portion 102 while the other gear remains in an open position.

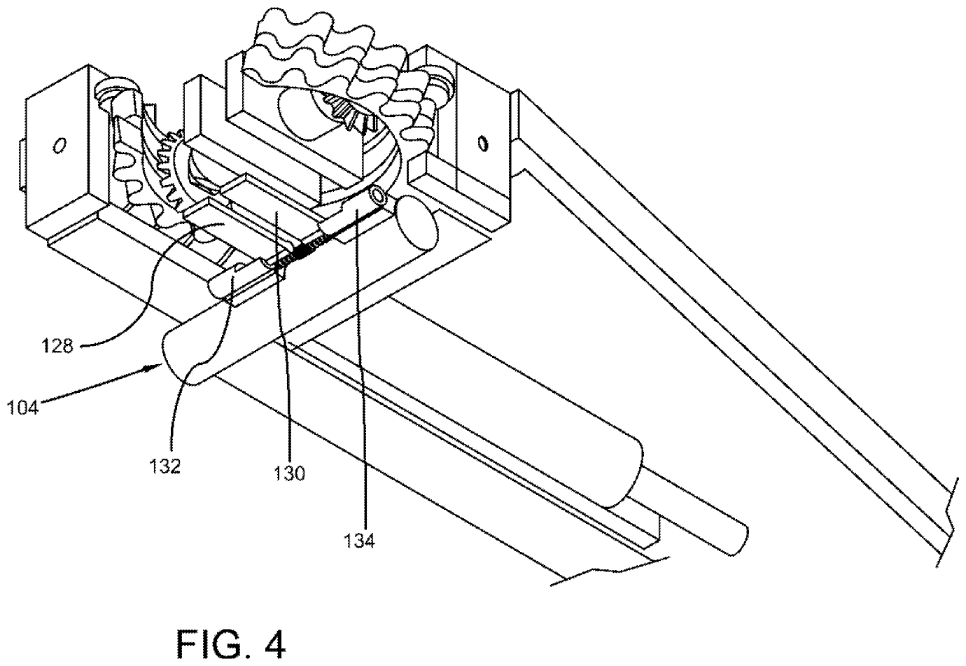

FIG. 4 illustrates a bottom perspective view of the multifunctional electric wrench of the present invention in accordance with the disclosed structure. The adjustable or second wrench portion 104 is positioned underneath the power wrench portion 102 which is formed using the ring or circular mount 106 and supported by the guide bars 118, 120. The second wrench portion 104 allows a user to drive up two pipes without using another tool. The second wrench portion 104 is driven by the gear which remains in the open position. The second wrench portion 104 includes a first leg 128 and a second leg 130 for accommodating a pipe therebetween.

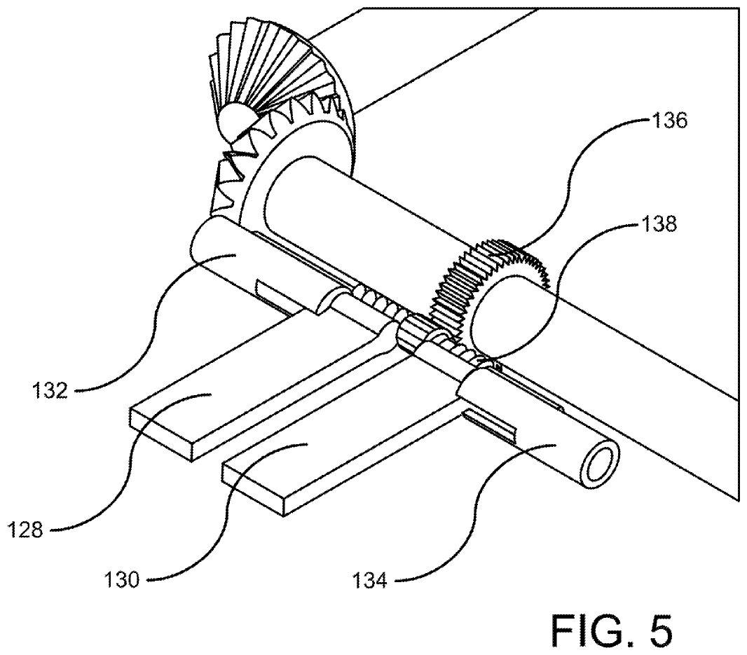

Referring to FIGS. 4 and 5, the second wrench portion 104 can also be adjusted for different nuts and bolts and includes a first sliding member 132 for the first leg 128. A second sliding member 134 is used for a second leg 130. The legs 128, 130 can laterally slide along the sliding members 132, 134 respectively for adjusting size of the second wrench portion 104. The sliding members 132, 134 are rotatably coupled to a gear 136 (side gear) using connected springs 138 for enabling pivotal movement relative to the first wrench portion 102.

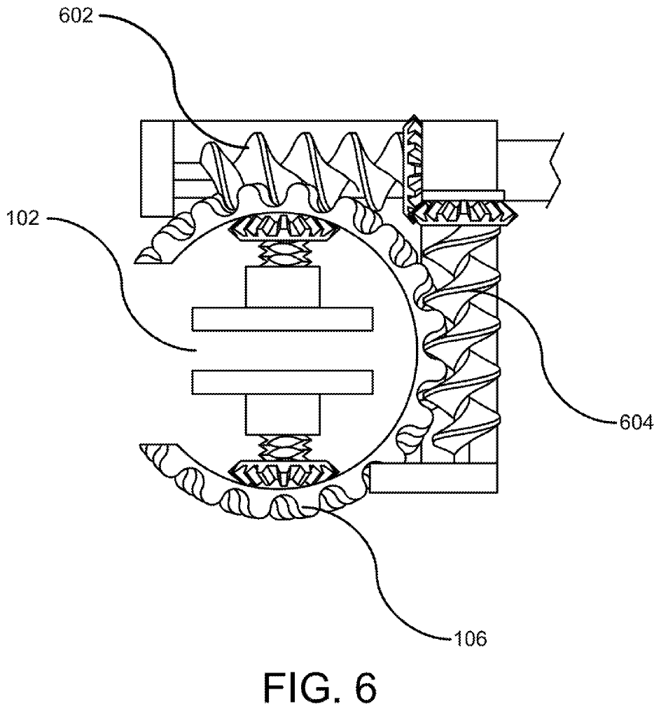

FIG. 6 illustrates the use of worm gears in the electric wrench device 100 of the present invention in accordance with the disclosed structure. The worm gears 602, 604 are included to couple with the ring or circular mount 106 while also providing additional physical support and strength to the wrench device 100. The worm gears 602, 604 help in coupling of the upper wrench portion 102 and the drill during rotation of drill.

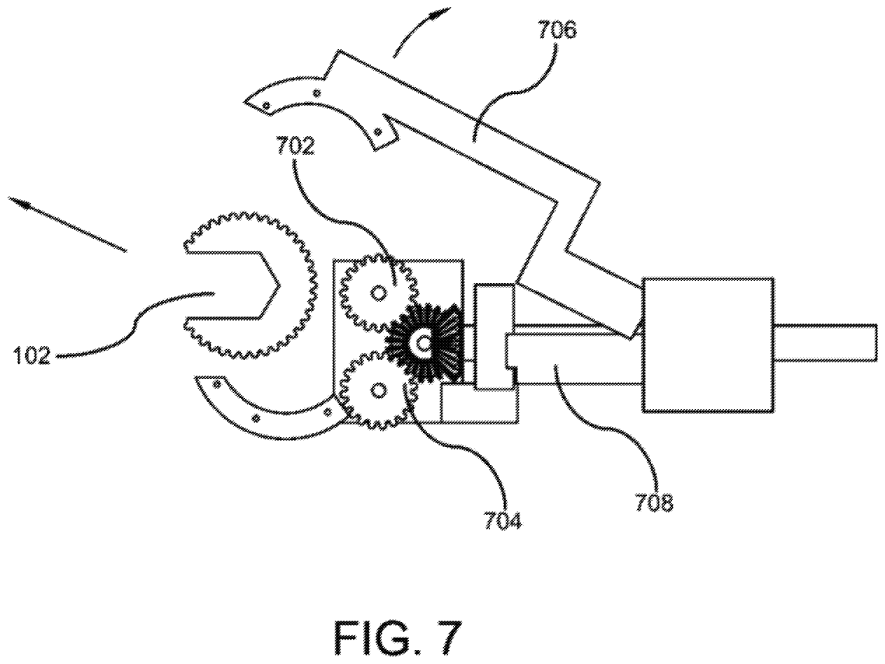

FIG. 7 illustrates the two gears method of the electric wrench for placing a pipe for drilling in accordance with the disclosed structure. As illustrated, the inside-gear-wrench portion 102 is open and rotates with two gears 702, 704. The one gear 702 remains in open place of the wrench portion 102 while the other gear drives the inside wrench portion 102. A first arm 706 and a second arm 708 are used for selection of the inside-gear-wrench portion 102 and is selected by one of the arms. The corresponding gear of the arm which selects the inside-gear-wrench portion 102 remains attached to the inside-gear-wrench portion 102.

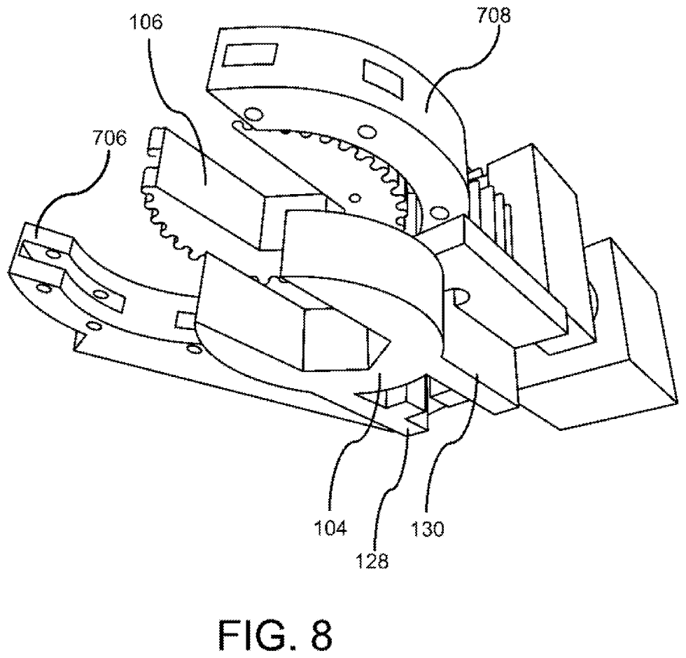

FIG. 8 illustrates another perspective view of the electric wrench of the present invention in accordance with the disclosed structure. As illustrated, the inside-gear-wrench portion 102 supported in the ring or circular mount 106 and by the arms 706, 708. Also, the second adjustable wrench portion 104 is positioned under the first wrench portion 102 for supporting a pipe without using any other tool.

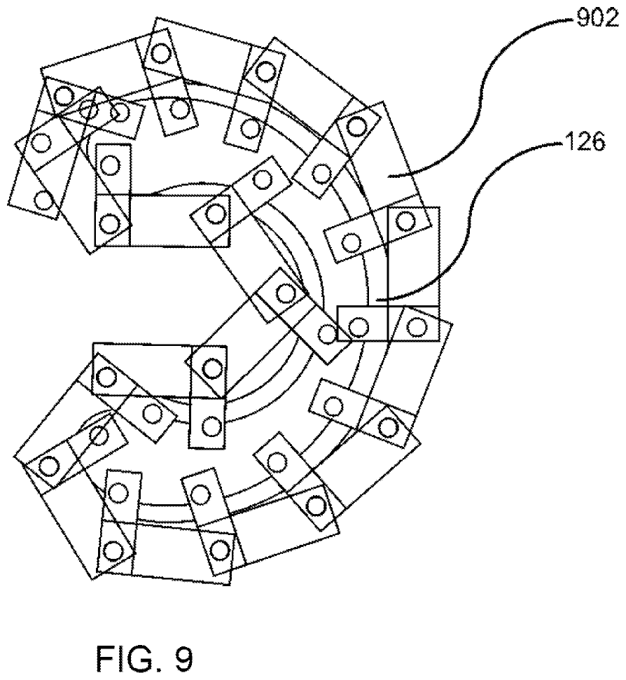

FIG. 9 illustrates the isolated view of the chain 126 used in the electric wrench of the present invention in accordance with the disclosed structure. The chain 126 is used with the open wrench portion 102 and includes interconnected links 902 which allow the chain 126 to maintain the shape as illustrated in FIG. 9 for easy driving and illustrated in FIGS. 1 and 2. The chain 126 helps in securing a pipe easily while easily driving the chain 126 using a motor.

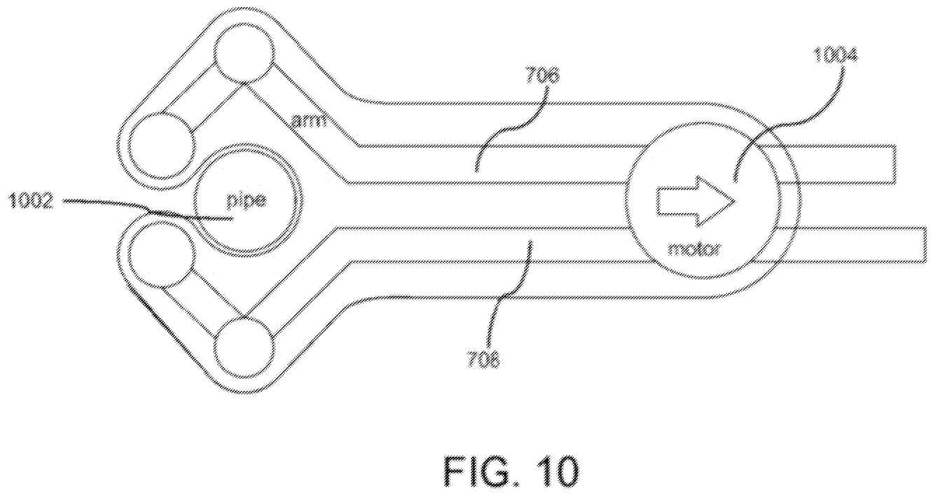

FIG. 10 illustrates the wrench to drive pipes with a chain or belt in accordance with the disclosed structure. The arms 706, 708 are designed like half quadrilateral and the chain or belt 126 is oriented along the arms 706, 708 such that a pipe 1002 is pushed to the inside wrench portion 102 and is secured by pushing the arms 706, 708. The motor 1004 is pulled for fastening the chain or belt 126 to secure the pipe 1002 securely for use with the wrench 100.

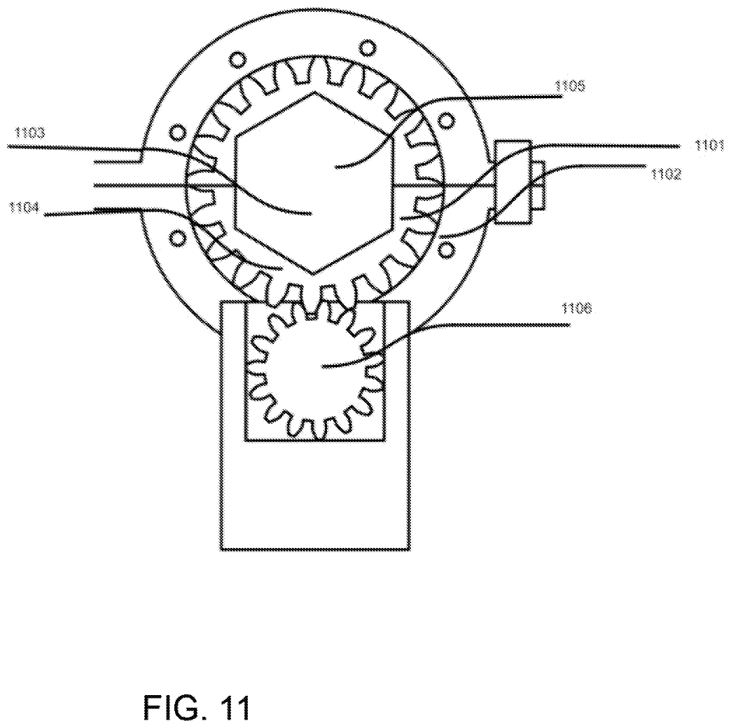

FIG. 11 illustrates how the electric wrench works by the fact that two half rings are entirely closed 1101 and locked 1102, locking the inside two half rings 1103 which have an exterior gear surface 1104, the interior surface is like wrench head 1105 that pushes one the other when driven by one gear 1106

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cylindrical protective device”, “protective device”, “cylindrical device”, and “device” are interchangeable and refer to the polished rod and packing protective device 100 of the present invention.

Notwithstanding the forgoing, the polished rod and packing protective device 100 of the present invention can be of any suitable size and configuration as is known in the art without affecting the overall concept of the invention, provided that it accomplishes the above stated objectives. One of ordinary skill in the art will appreciate that the polished rod and packing protective device 100 as shown in the FIGS. 1-3 are for illustrative purposes only, and that many other sizes and shapes of the polished rod and packing protective device 100 are well within the scope of the present disclosure. Although the dimensions of the polished rod and packing protective device 100 are important design parameters for user convenience, the polished rod and packing protective device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electric wrench for tightening and loosening pipes, nuts and bolts, the electric wrench comprising:
A ring that closes completely inside turns two half rings with exterior gear surfaces pushing each other through one gear outside by a motor.

2. An electric wrench for tightening and loosening pipes, nuts, and bolts according to claim 1, the electric wrench further comprising: A three-quarter ring that internally rotates one three-quarter ring with an exterior gear surface through two gears externally by a motor.

3. An electric wrench for tightening and loosening pipes, nuts and bolts according to claim 1, the electric wrench further comprising: A chain or belt that rings around three-quarters of the pipe and rotates through a motor.

4. An electric wrench for tightening and loosening pipes, nuts and bolts according to claim 1, the electric wrench further comprising a wrench attached to a second wrench to enhance control without using a second tool.
